(19) United States
(12) Patent Application Publication
(10) Pub. No.: US 2013/0180603 A1
(43) Pub. Date: Jul. 18, 2013

(54) IRRIGATION SYSTEM AND METHOD

(71) Applicant: Kifco Inc., Havana, IL (US)

(72) Inventors: Christopher L. Clevenger, Bryn Mawr, PA (US); John Arthur Mc Hugh, Loveland, CO (US)

(73) Assignee: Kifco Inc., Havana, IL (US)

(21) Appl. No.: 13/741,089

(22) Filed: Jan. 14, 2013

Related U.S. Application Data
(63) Continuation of application No. 13/739,890, filed on Jan. 11, 2013.
(60) Provisional application No. 61/586,212, filed on Jan. 13, 2012.

(51) Int. Cl. F17D 1/08

(52) U.S. Cl. CPC F17D 1/08
USPC 137/315.01; 137/355.16

(57) ABSTRACT

A system includes a lateral and a socket. The lateral has a first end and a second end separated by a length of a lumen. At least one of the first end and second end is configured to couple with a fluid supply. The length has a plurality of apertures in a wall of the lumen. Each aperture is in fluid communication with the lumen and disposed along a line substantially parallel with a length axis. The length is configured to allow non-destructive coiling about a reel and non-destructive uncoiling. The length has a cross section sufficiently rigid to resist deformation associated with fluid in the lumen. The socket is coupled to the length at a site of at least one aperture. The socket has a bore in fluid communication with the aperture.

### CLAIM OF PRIORITY

This patent application is a continuation of and claims priority under 35 U.S.C. §120 to U.S. patent application Ser. No. 13/739,890, filed on Jan. 11, 2013, which claims the benefit of priority, under 35 U.S.C. Section 119(e), to U.S. Provisional Patent Application Ser. No. 61/586,212, entitled “IRRIGATION SYSTEM AND METHOD,” filed on Jan. 13, 2012, Attorney Docket No. 3540.001PRV, which is hereby incorporated by reference herein in its entirety.

### BACKGROUND

Permanent and semi-permanent above-ground irrigation systems typically use application devices (impact sprinklers, pop-up sprinklers, rotators or emitters) positioned along an irrigation lateral (pipe, tube or hose) to distribute water. The application devices are typically stationary while in operation. The application device can be coupled directly to the lateral or coupled to the lateral by a short riser aligned vertically and having a typical length of 3 to 48 inches.

An irrigation lateral can be fabricated of aluminum (sometimes referred to as hand line) or PVC (sometimes referred to as solid set) pipe in standard dimensions of 20, 30, 40, or 50 feet and having an application device attached at one end of each length. The lengths of lateral are equipped with a coupler to allow separate lengths to be connected in an end-to-end manner.

Assembly and disassembly of a lateral suitable for a large field requires considerable labor and the systems are bulky and expensive to transport and store. Dismantled individual components are susceptible to damage and theft.

### OVERVIEW

An example embodiment of the present subject matter pertains generally to an irrigation system comprising an irrigation lateral in which a series of apertures are disposed along a length of the lateral. The apertures are configured to receive an application device or a riser. One example relates to a method of using an irrigation system.

The present inventors have recognized, among other things, that a problem to be solved can include providing an irrigation lateral configured for winding on a reel. The present subject matter can include a lateral having apertures configured to receive an application device or a riser. The application device or riser is configured to couple with the lateral using a socket, or other engagement feature.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components.

The drawings illustrate generally, by way of example, but not by way of limitation, various embodiments discussed in the present document.

FIG. 1 illustrates a view of an irrigation system, according to one example.

FIG. 2 illustrates a view of a lateral, according to one example.

FIG. 3 illustrates a view of a socket, according to one example.

FIG. 4 illustrates a view of a lateral, according to one example.

FIG. 5 illustrates a section view of a lateral, according to one example.

FIG. 6 illustrates a section view of a lateral, according to one example.

FIG. 7 illustrates a section view of a socket, according to one example.

FIG. 8 illustrates a section view of a socket, according to one example.

FIG. 9A illustrates a section view of an aperture in a lateral, according to one example.

FIG. 9B illustrates a section view of an aperture in a lateral, according to one example.

FIG. 10 illustrates a section view of a socket in a lateral, according to one example.

FIGS. 11A and 11B illustrate section views of device bodies in a lateral, according to various examples.

FIG. 12 illustrates a view of an application device and a lateral, according to one example.

FIG. 13 illustrates a view of a riser, according to one example.

FIG. 14 illustrates a view of a reel, according to one example.

FIG. 15 illustrates a view of a coupler, according to one example.

FIG. 16 includes a method, according to one example.

### DETAILED DESCRIPTION

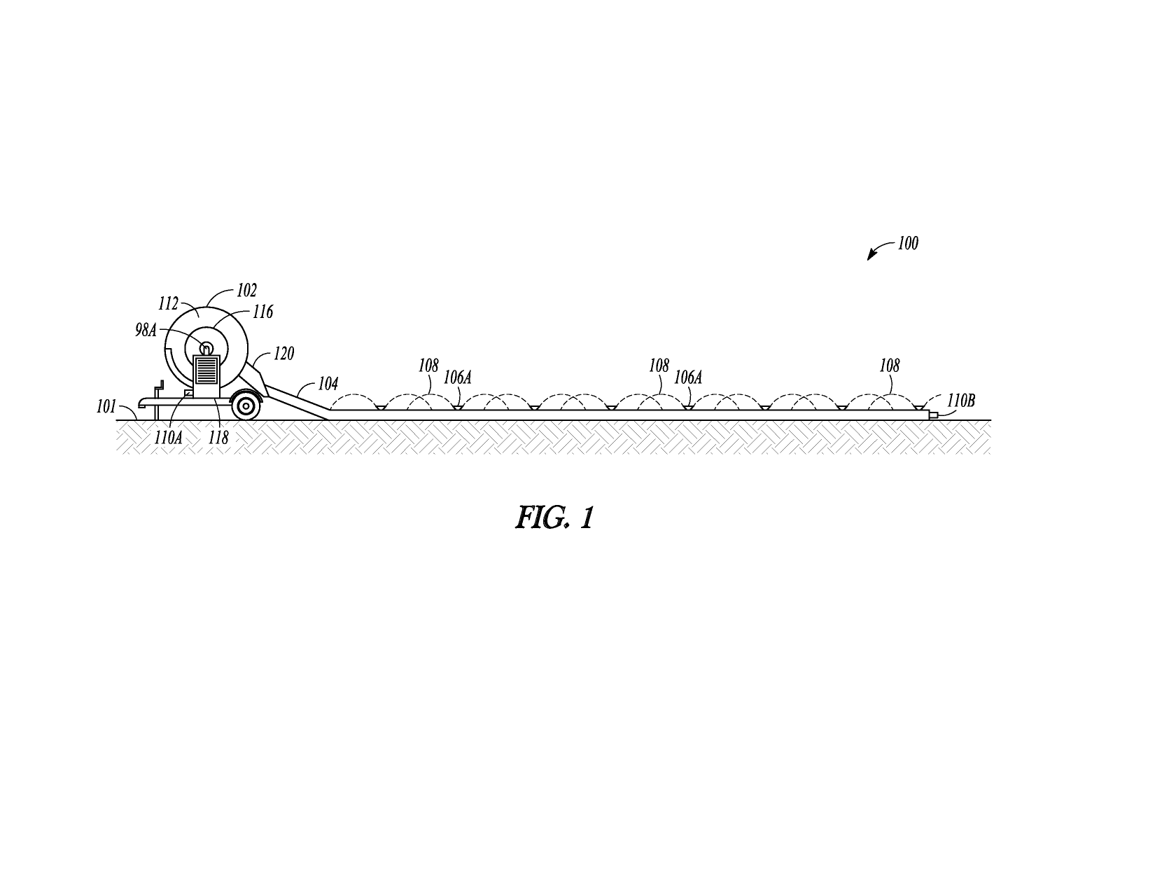

FIG. 1 illustrates system 100, according to one example. System 100 sometimes referred to as a reel-line irrigation system, includes reel 102, and lateral 104. The figure shows system 100 deployed on a surface of field 101. In a deployed configuration, lateral 104 is uncoiled or laid out on field 101. In a wound configuration, lateral 104 is coiled on reel 102.

Reel 102 is supported by bearing 98A connected to chassis 118. Chassis 118 includes an axle and wheel assembly to allow towing into position. Bearing 98A allows reel 102 to rotate on an axis relative to chassis 118. Reel 102 can be motor driven or manually driven. Reel 102 includes core 116 on which lateral 104 can be wound and includes end walls 112 to maintain the wound lateral 104 on core 116. In various examples, reel 102 is mounted on a trailer or a flatbed.

Lateral 104 includes a pipe, a tube, or a hose. In the example shown, lateral 104 is connected to coupler 110A disposed at a first end (proximate reel 102) and connected to coupler 110B disposed at a second end. Either one or both of coupler 110A and coupler 110B can be connected to a supply line. Coupler 110A or coupler 110B can include a threaded or threadless plumbing joint and can be located at a convenient position relative to lateral 104 or directly connected on lateral 104. In the example shown, coupler 110A is in fluid communication with lateral 104 by means of a plumbing line that may be hidden by a portion of the chassis or reel 102.

Lateral 104 includes a length having a plurality of apertures, and in the example shown, each aperture is fitted with an application device 106A. Eight such application devices 106A are shown in this example, however the number of apertures (or the number of application devices) can be greater or smaller. In one example, lateral 104 includes a plastic tube having sufficient flexibility to wind about reel 102 for storage and transit. In the example shown, mechanism 120 is configured to uniformly control winding and unwinding of lateral 104 on reel 102.

In one example, level-wind mechanism 120 is configured to guide lateral 104 evenly onto reel 102 during winding. Level-wind mechanism 120 includes an indexing screw or reciprocating chain drive, which acts on a fork guiding and distributing lateral 104 evenly onto reel 102.

Lateral 104 can be stored or transported in the coiled position on reel 102 and deployed by pulling lateral 104 into field 101. Lateral 104 can be deployed by using a motor vehicle, such as a tractor, by using an animal, or manually (such as a winch). The lumen of lateral 104 maintains a substantially fixed cross-section when coiled on reel 102. The lumen of lateral 104, in one example, is configured to maintain patency while coiled about reel 102. In contrast, a lay-flat type of irrigation hose will take a collapsed configuration when coiled and is thus unable to maintain patency.

System 100 is configured to allow lateral 104 to be wound onto reel 102. System 100 can be moved into a position on field 101 and lateral 104 can be unwound from reel 102 and positioned for irrigating. A supply line can be connected to a coupler, such as coupler 110A or coupler 110B, of lateral 104. Application device 106A is configured to distribute water or other fluid as shown by spray pattern 108.

System 100, in the example shown, can remain deployed in field 101 during irrigation. As such, lateral 104 remains coupled to reel 102 and reel 102 remains attached to chassis 118.

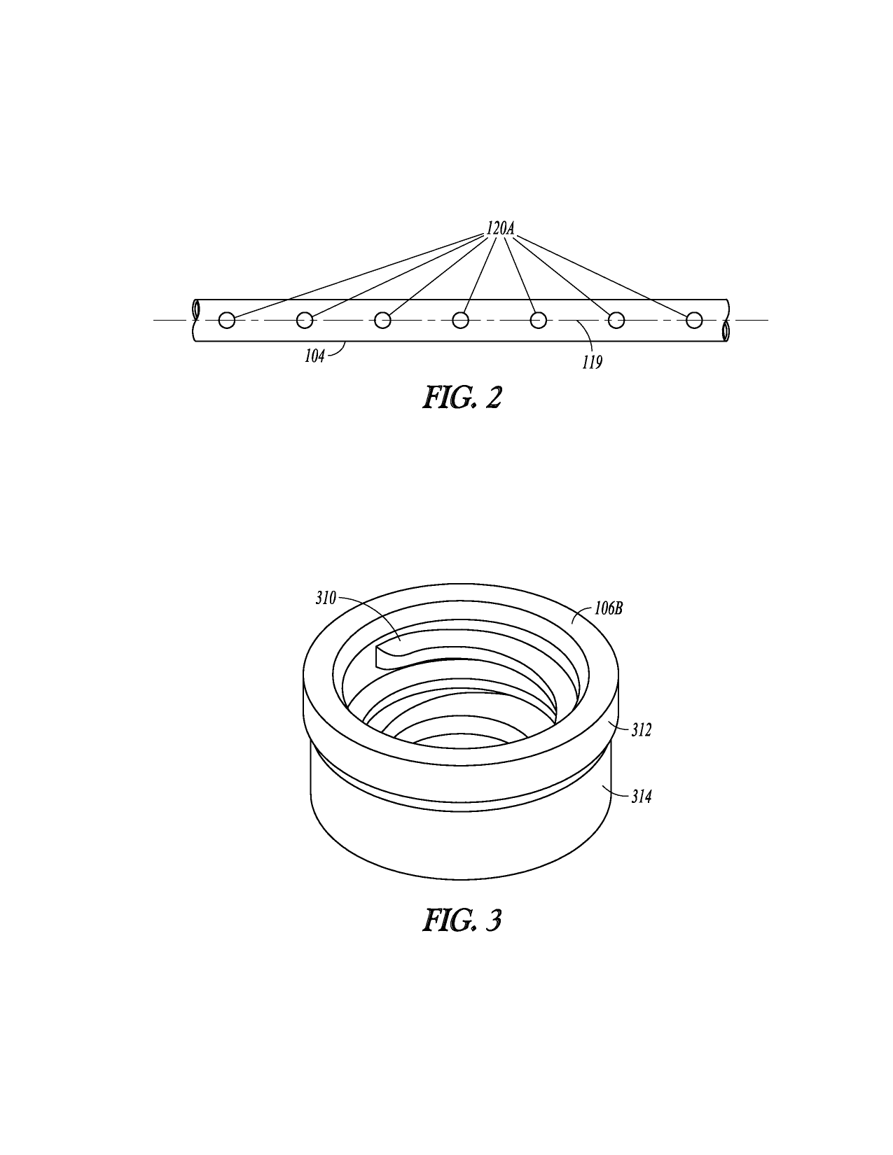

FIG. 2 illustrates a view of lateral 104, according to one example. In the figure, apertures 120A are disposed along common axis 119 of lateral 104. The alignment of apertures 120A allows discharge of fluid in a direction substantially normal to the field on which lateral 104 is deployed. Aperture 120A can be formed by drilling, punching, melting, molding, or other fabrication process. Aperture 120A can have a circular form (as shown in the figure) or other forms.

FIG. 3 illustrates a view of socket 106B, according to one example. Socket 106B includes internal threads 310 configured to mate with corresponding threads of an application device. Socket 106B includes an outer surface 314 configured to engage with an aperture in lateral 104. Socket 106B includes shoulder 312 having an outside diameter greater than that of surface 314. Shoulder 312 is configured to abut a surface of lateral 104. Socket 106B can be fabricated of a polymer or a metal.

Socket 106B can be attached or inserted into an aperture of lateral 104 and retained in lateral 104 by an interference fit along the dimensions of surface 312. In one example, socket 106B is fused or bonded to lateral 104.

An internal bore of socket 106B is in fluid communication with the lumen of lateral 104.

Threads 310, or another retention mechanism, allow attachment or detachment of an application device, a pop-up application device, a riser, or another lateral, to lateral 104. In one example, socket 106B includes internal threads or snap-in type threads or formations corresponding to a complementary device (or riser or lateral).

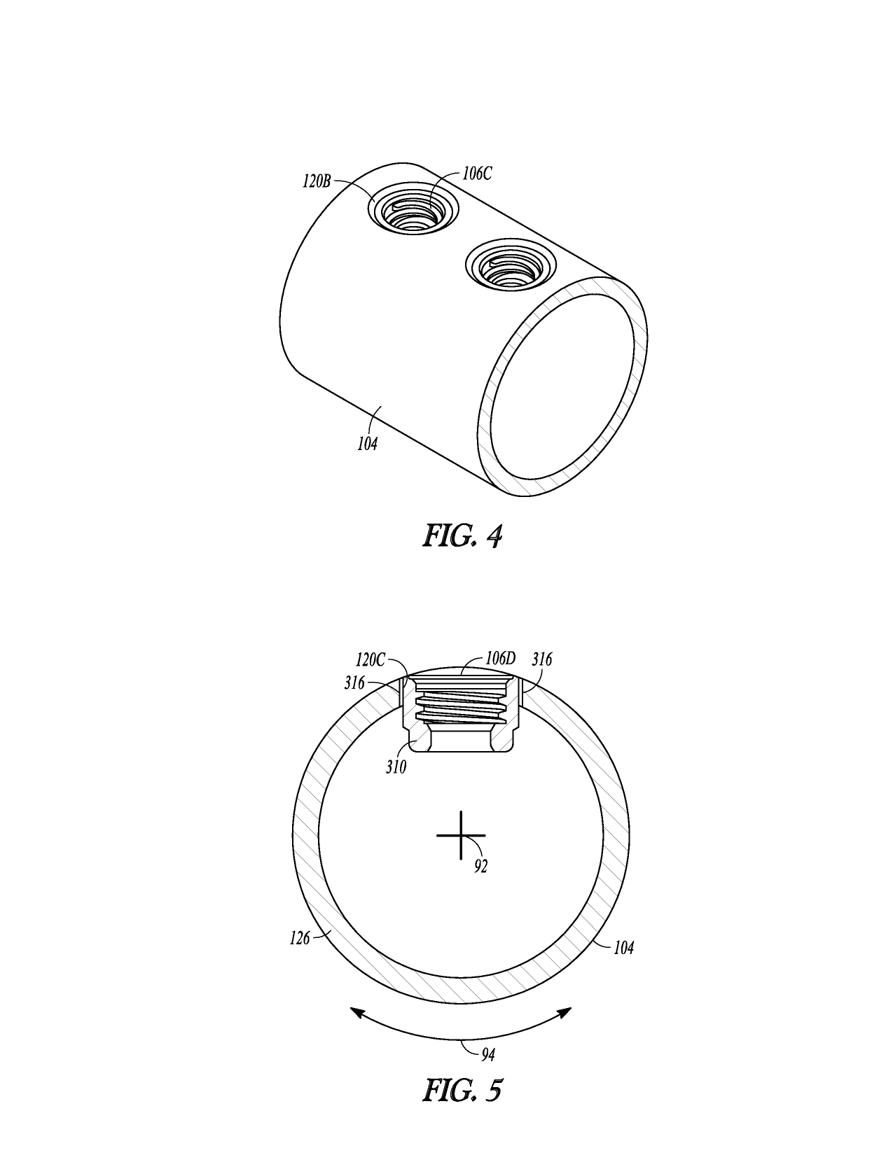

FIG. 4 illustrates a view of socket 106C disposed in an aperture 120B of lateral 104. Internal threads of socket 106C are configured to facilitate rapid attachment and detachment of an application device and thus allow for convenient winding and unwinding of lateral 104. A threaded socket, such as socket 106C, allows for simple replacement of application devices and for removal of risers prior to winding lateral 104 on reel 102.

FIG. 5 illustrates a section view of socket 106D in lateral 104. Socket 106D, in the example shown, includes socket wall 310 configured for interference fit at surface 316 relative to wall 126 of lateral 104.

Lateral 104, in the example shown, has sufficient rigidity to resist deformation. A lay-flat hose, in contrast to that of lateral 104, has a wall thickness that allows for collapse in the absence of fluid pressure. As such, fluid pressure in the hose causes deformation of the wall and a corresponding change in the alignment of an aperture in the wall. Lateral 104, on the other hand, has a substantially rigid wall 126. Wall 126 has sufficient thickness and is fabricated of a material selected to maintain sufficient rigidity without deformation when subjected to typical fluid pressures associated with irrigation systems. A typical fluid pressure in an irrigation system can be 40 psi. In addition, one example includes a wall 126 configured to preclude kinking or to resist kinking when wound on reel 102. A kink in the wall can be construed as destructive. In one example, lateral 104 maintains a substantially fixed cross section when wound on reel 102.

In one example, wall 126 is configured to resist rotation or twisting about axis 92 of lateral 104, as shown at arrow 94. In this manner, a riser set for a particular alignment relative to the field will remain in a substantially fixed position without regard for fluid pressure or forces exerted by a moderate wind.

In one example, socket 106D is affixed to lateral 104 by an adhesion technique, or by a bond, fuse, or thread. Socket 106D is affixed to lateral 104 such that a strong, durable and water tight seal is formed. In one example, surface 312 (FIG. 3) has a diameter greater than that of aperture 120C, thus forming an interference fit at surface 316.

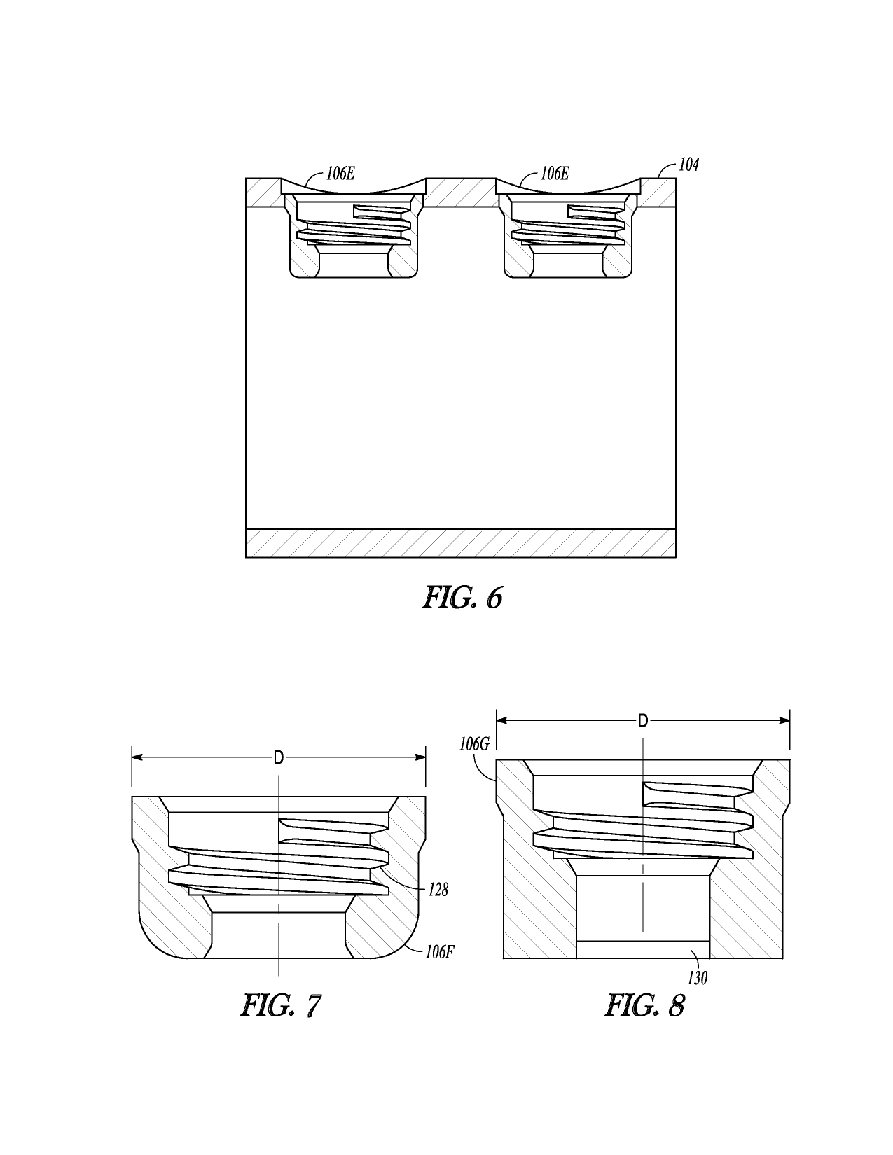

FIG. 6 illustrates a section view of lateral 104 having sockets 106E. Sockets 106E, in the example shown in the figure, are seated below the outer diameter of lateral 104. In one example, sockets 106E are fusion welded to lateral 104. Fusion welding can include application of thermal energy (heat) to the bonding surfaces and before cooling, bringing the surfaces into direct contact.

In one example, socket 106E is glued in an aperture using an adhesive such as epoxy. In one example, the joint is formed by a fusion weld process using heat and pressure. Fusion welding can include application of heat, vibration, sonic or other fusion technology.

FIG. 7 illustrates socket 106F having an unrestricted center bore and diameter having dimension D. Internal threads 128 can include an Acme thread, a pipe thread, a machine thread, or other type of thread.

FIG. 8 illustrates socket 106G having check valve 130. Check valve 130 can include a leaf valve, a ball valve, or other type of valve configured to restrict discharge of fluid from the socket bore in the absence of an application device or other fitting engaged with the internal threads of socket 106G. In one example, check valve 130 closes when pressure is below a specified level as controlled by a spring, flapper or plunger and seal. Check valve 130 allows a user to keep the system charged with water when not in use without applying water to the field, and thus avoid a condition sometimes referred to as drain-down. Drain-down occurs when water pressure is shutoff and the application devices lose pressure slowly and eventually drain completely out of the application devices or pressure sealed joint in between the lengths of pipe. By allowing the system to remain under pressure (charged completely with water), yet not apply water, check valve 130 can prevent drain-down and allow the user to resume irrigating without refilling the system. This practice reduces wasted water and greatly improves uniformity at system startup and shutdown.

In one example, check valve 130 is in the normally closed position and is open when a riser or application device is inserted. The base or the threads of the riser (or application device) depress or open the valve when inserted. In this configuration, check valve 130 allows the user to selectively use the sockets for application devices or risers in the event a complete length of lateral is not in use or necessary and remains on the reel 102.

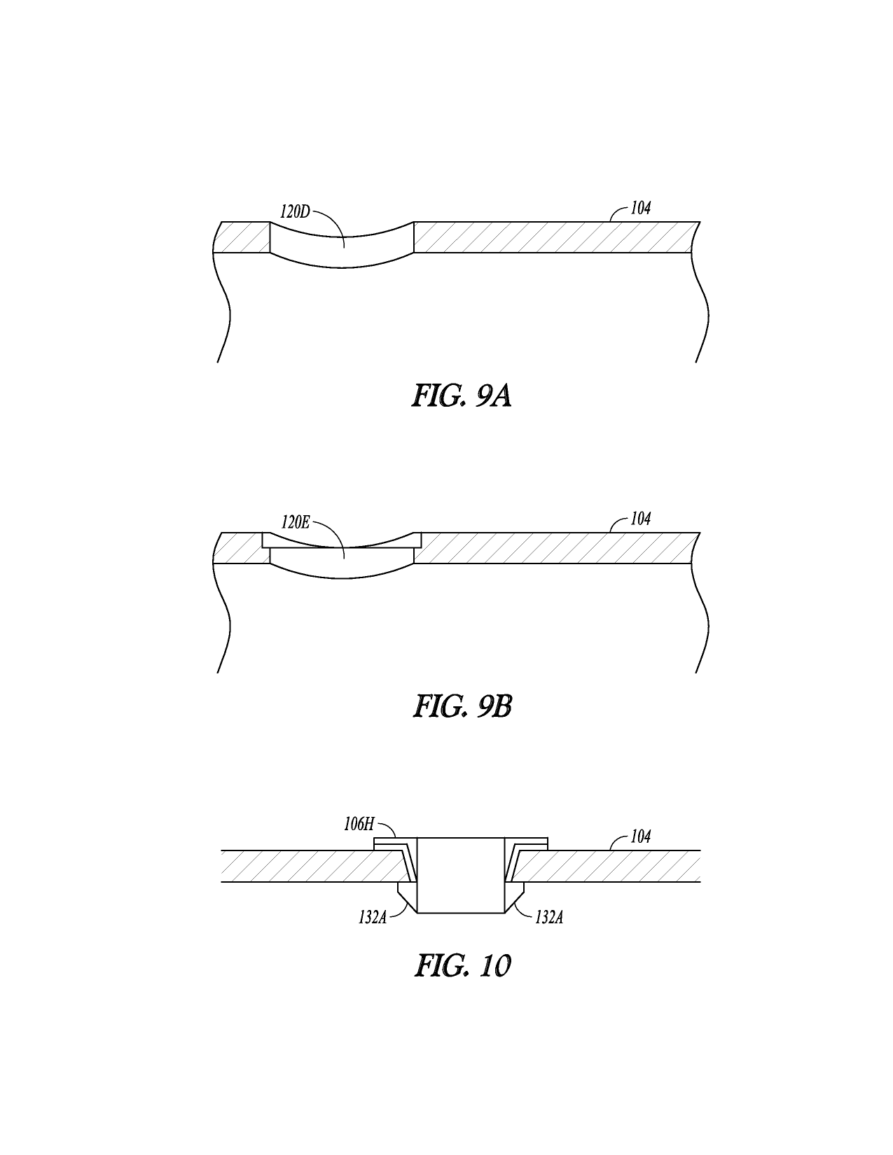

FIG. 9A illustrates a view of aperture 120D in lateral 104 according to one example. Aperture 120D includes a cylindrical wall profile.

FIG. 9B illustrates a view of aperture 120E in lateral 104 according to one example. Aperture 120E includes a counter bore wall profile. Other aperture profiles are also contemplated, including a tapered or conical wall profile. A counter bore profile, such as shown at aperture 120E, can be used when a socket is to be fusion welded into lateral 104. Application of heat, in forming a fused joint having an interference fit, causes liquid fusion material created by the heated socket fusion surface and lateral wall to be displaced into the counter bore clearance region. The liquid fusion material which displaces into the counter bore clearance region can improve the strength of the fusion weld between the socket and lateral wall.

In one example, lateral 104 can be softened by a heat gun, ultraviolet (UV) light, or by chemical means, or in any other manner, so that the socket can puncture the softened side wall and form its own aperture in which it sits. In some examples, and depending on the thickness and strength of the material selected for the lateral 104, pre-forming of an aperture or softening of the lateral sidewall may be omitted in fitting an application device into lateral 104. In some examples, a socket can be pushed directly into and through the sidewall of the lateral. The features of one embodiment of a socket may also be used in another embodiment in an appropriate manner, or used directly on the body of an application device to permanently secure an application device of the pop-up type into the sidewall of a lateral.

FIG. 10 illustrates socket 106H connected to lateral 104. Socket 106H includes a threadless bore. Socket 106H can be fusion welded to an exterior surface of lateral 104 in a process referred to as saddle fusion. A saddle fusion joint is bonded about a flange area disposed on the exterior surface of lateral 104 (here the upper surface shown in the figure).

Socket 106H includes circular barb 132A disposed on an interior surface of lateral 104. Barb 132A serves to lock socket 106H in position on the wall of lateral 104. In addition, barb 132A provides a watertight seal when under pressure and serves to help prevent the socket 106H from being ejected from lateral 104 under pressure of the fluid supplied. Barb 132A also stabilizes the application device or riser coupled to socket 106H.

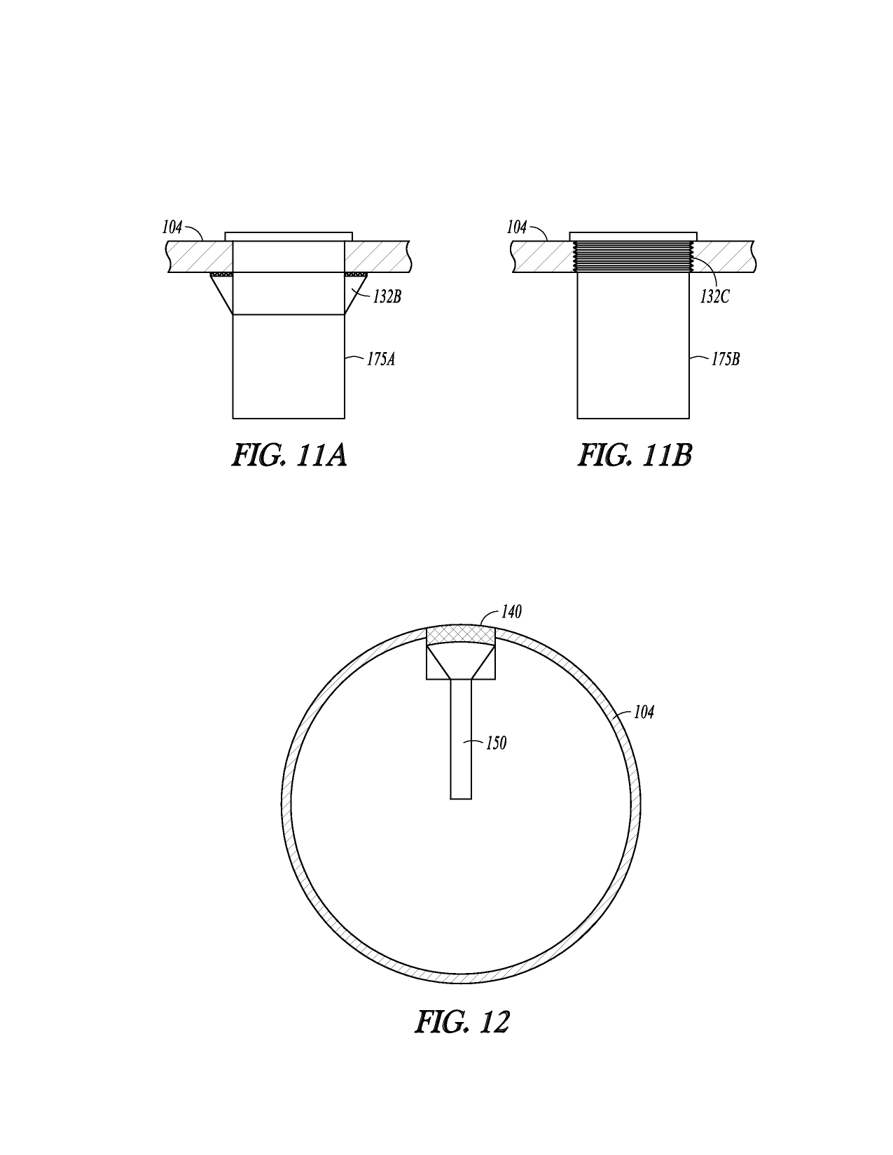

FIGS. 11A and 11B illustrate device body 175A and 175B, respectively. Device body 175A and device body 175B can be part of an application device (such as a sprinkler), a socket, or a portion of an application device or a portion of a socket. Other configurations of device bodies, having engagement features different than those shown in the figures, are also contemplate.

Device body 175A, as shown in FIG. 11A has an outer flange (on an outer surface of lateral 104) and has a circular barb 132B configured to engage an internal surface of lateral 104. Alignment of device body 175A relative to lateral 104 is maintained by a relatively tight fit between device body 175A and the aperture of lateral 104. In the example shown, device body 175A has a smooth wall at the juncture with the wall of the aperture in lateral 104.

Device body 175B, as shown in FIG. 11B, has an outer flange (on an outer surface of lateral 104) and has an external thread 132C configured to engage the wall of lateral 104. Thread 132C can be self-tapping and thus form a thread concurrent with installation or thread 132C can be configured to engage threads formed in lateral 104 prior to installation.

FIG. 12 illustrates a view of pop-up type of application device 150 and lateral 104. Device 150 includes outer surface 140 and in the example shown, outer surface 140 is substantially flush with an external surface of lateral 104. Device 150 has a first configuration in which a reduced fluid pressure in lateral 104 allows surface 140 to lie substantially flush and has a second configuration in which an increased fluid pressure in lateral 104 allows surface 140 to eject to a deployed position. In the deployed position, surface 140 is substantially above the lateral 104 and fluid in lateral 104 is deflected or directed in a manner for irrigation.

In one example, a pop-up application device in a retracted position has an outer surface that extends about an eighth of an inch above the outer diameter of the lateral 104. This substantially flush fitting or low profile configuration of the outer surface allows for a substantially smooth cross section of lateral 104 along its length and allows lateral 104 to be wound up on reel 102.

A pop-up type of application device can also include any variety of a telescoping device in which tubular members are slidably engaged.

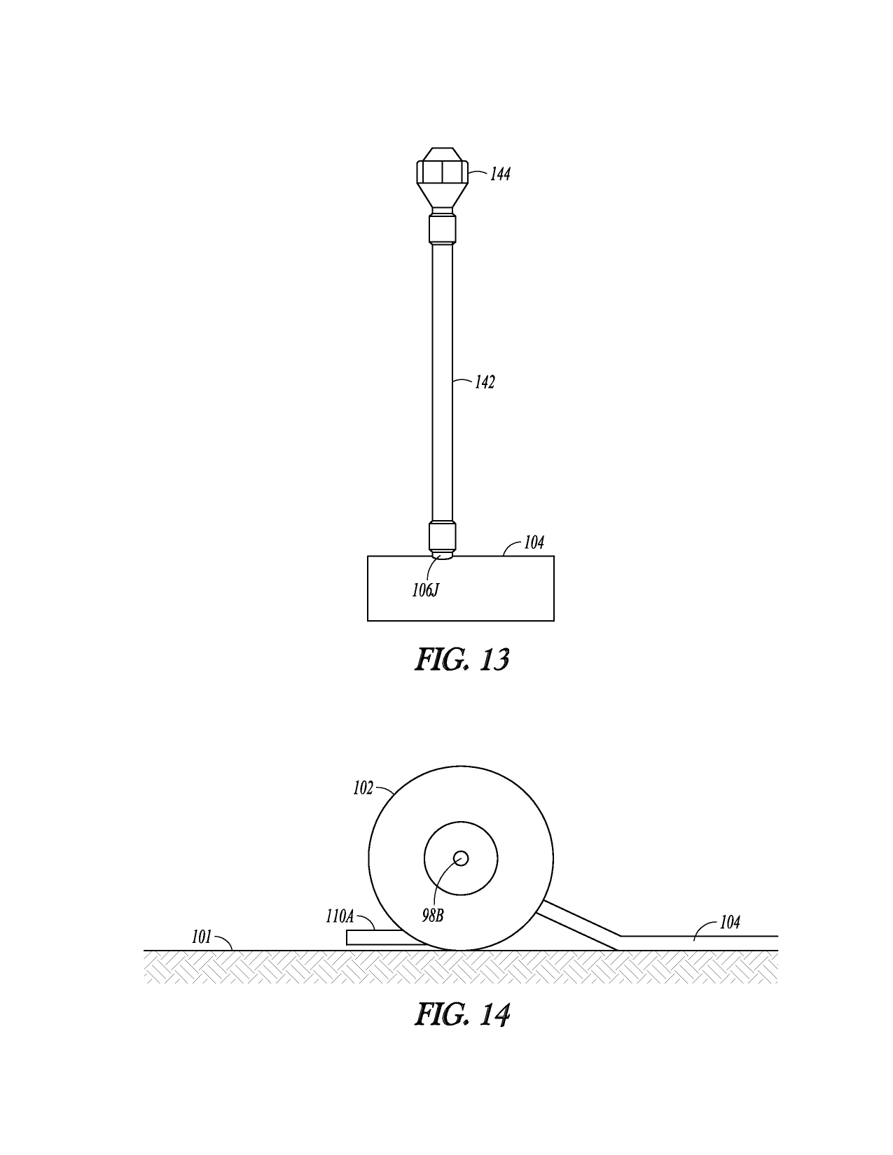

FIG. 13 illustrates a view of riser 142. Riser 142 is coupled to lateral 104 by socket 106J. Socket 106J can be connected to lateral 104 by a saddle fused joint, a socket fused joint, or by another attachment mechanism. Riser 142 is connected to application device 144. Riser 142 is configured to provide an improved spray pattern from application device 144.

Riser 142 and riser-mounted application device 144 can be affixed to lateral 104 using threads or a tab-and-notch style coupler such that they are sealed and in fluid communication with the lumen of lateral 104. Riser 142 can be installed during pull-out of lateral 104 from reel 102 or after lateral 104 is pulled into position on field 101. Riser 142 and application devices can be removed prior to, or during, winding of lateral 104 onto reel 102.

In one example, application device 144 is mounted on a removable vertical riser 142. In this example, application device 144 is affixed to the top of vertical PVC, plastic or aluminum riser 142 in order to increase the height of application device 144. Additional height can increase irrigated radius and uniformity and clears crops or vegetation which is taller than the top of the lateral.

FIG. 14 includes a view of lateral 104 with reel 102 positioned on field 101. In this example, lateral 104 can be connected to a supply line at coupler 110A and reel 102 is supported by the field 101 and not carried by a chassis. In this manner, the chassis (not shown) is unburdened and available for storing or transporting another reel (not shown).

Bearing 98B is configured as a joint that can allow removal of reel 102 from a chassis or other structure. In one configuration, bearing 98B allows tool-less removal and reinstallation. In one example, bearing 98B includes slidably engaging members that can be deployed or withdrawn by manual or powered means.

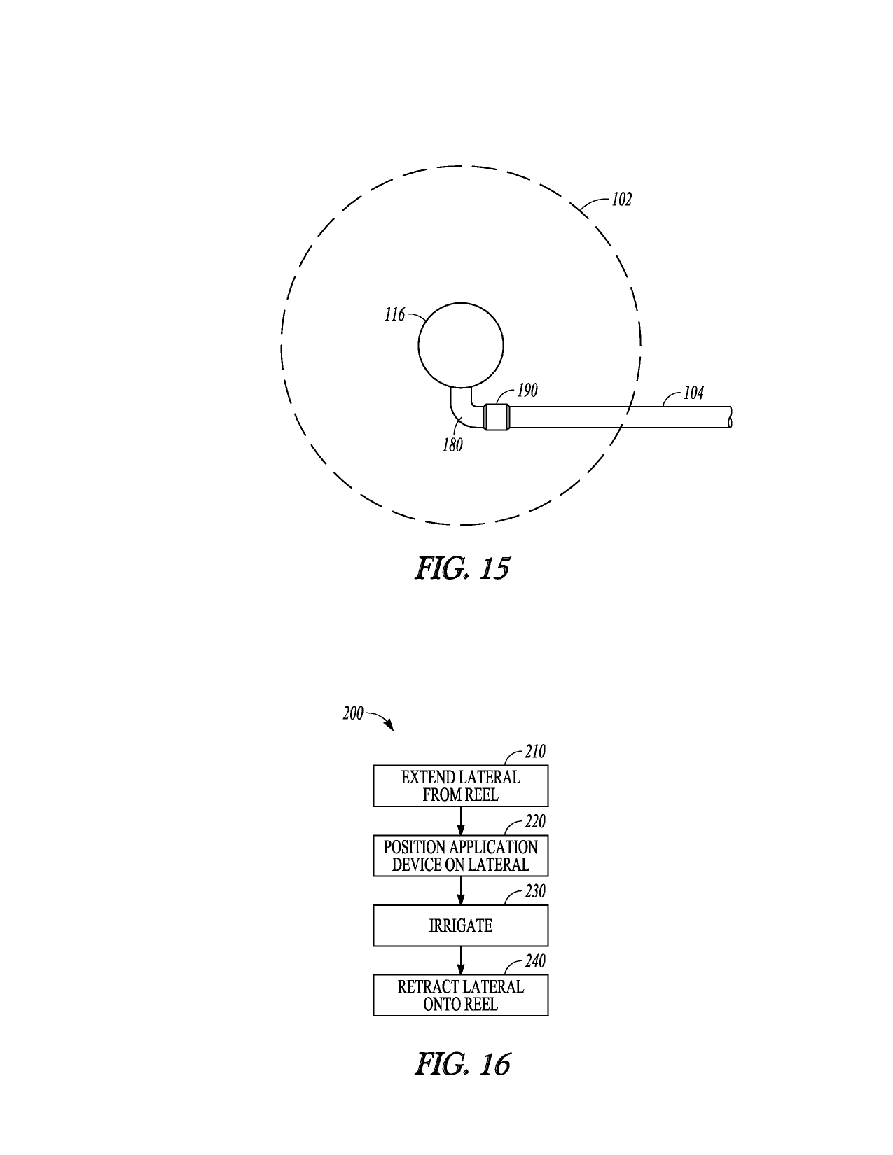

In one example, such as that shown at FIG. 15, lateral 104 is connected to reel 102 by a joint, here denoted as coupler 190. In addition to coupler 190 providing a joint between reel 102 and lateral 104 in the manner shown, coupler 190 can also provide a joint to directly connect lateral 104 to a supply line (or to a termination plug and, in which case, another coupler provides a joint with a supply line), and thus, reel 102 can be unburdened and thus available for storing or transporting another lateral (not shown).

Reel 102 can be mounted on a wheeled chassis, a trailer, a flatbed truck, or placed directly on the surface of field 101 (as shown in FIG. 14). In one example, reel 102 has end walls 112 and a cylindrical core 116 on which lateral 104 can be wound. In one example, system 100 includes a gas-powered retraction engine mounted and configured for rotating reel 102 under power in order to wind lateral 104 onto core 116. The retraction engine may also provide power to a venting compressor selectively coupleable to lateral 104 for blowing water out of lateral 104 (such as through the application devices) prior to winding lateral 104 onto reel 102.

Chassis 118 (FIG. 1) can be equipped with various mechanism associated with reel 102 and lateral 104. For example, chassis 118 can be configured to retract or wind lateral 104 and configured to drain, vent, or discharge the water from lateral 104.

In one example, chassis 118 includes a framework for mounting on a tractor. Such a mount can include a three-point attachment.

In one example, a motor or auxiliary drive mechanism (power take-off, or PTO) can provide rotary motion to reel 102. A motor can also supply power to detach reel 102 from chassis 118 and to re-attach reel 102 to chassis 118, or supply power for raising or lowering stabilizer legs into the ground, and to supply power to a venting compressor coupled to lateral 104 for blowing water out of the lateral 104, through the application devices, or through a drain valve disposed in lateral 104. Standing fluid in lateral 104 can add substantial weight and removing the fluid prior to winding can reduce the load presented to system 100.

In one example, an end of lateral 104 is coupled to a stable pullout cart. The pullout cart can be attached to a vehicle and can facilitate deployment of lateral 104 in field 101. The pullout cart can be drawn away from the chassis 118 or the pullout cart can be affixed to the ground and reel 102 and chassis 118 can be withdrawn from the pullout cart to deploy lateral 104. The pullout cart can be affixed to an end of lateral 104 and resist twisting of lateral 104.

Lateral 104 can be fabricated of plastic such as polyethylene. In one example, lateral 104 includes medium density polyethylene tubing. The lateral inside diameter and wall thickness can be any dimension. In some examples, the diameter dimensions are in the range of 2 to 6 inches. In some examples, the wall thickness of lateral 104 can be in the range 0.19 to 0.40 inches. In one example, a pop-up application device can be responsive to water pressure in the range of 20 to 60 psi.

In one example, the present subject matter includes method 200 such as that shown in FIG. 16. Method 200 includes, at 210, extending a lateral from a reel. Extending can include maintaining a chassis-mounted reel in a fixed position and pulling a free end of a lateral using a motor vehicle. Extending can include maintaining a free end of a lateral in a fixed position and using a motor vehicle to move a chassis-mounted reel.

Method 200 includes, at 220, positioning a plurality of application devices on the lateral. The application devices can include a sprinkler or a riser-mounted sprinkler device. In one example, positioning can include engaging a threaded fastener or engaging a tool-less coupling. In one example, positioning can include applying fluid pressure to the lateral to cause deployment of a pop-up application device.

Method 200 includes, at 230, irrigating using the lateral. Irrigating can include delivering water or water-based material using a pressurized source.

Method 200 includes, at 240, retracting the lateral onto the reel. Retracting can include removing or re-positioning a plurality of application devices.

Other example methods are also contemplated. In one example, the method includes disconnecting the reel from a chassis and placing the reel directly on the field. In various examples, the lateral can be connected to a supply line by coupler 190 (coupler 190 remains affixed to the lateral and separated from, and thus independent of, the reel), the lateral can be connected to the supply line by coupler 110A (and thus fluid is carried to the reel by a line connected to the reel, as described with respect to FIG. 1, and carried from the reel to the lateral by coupler 190), the lateral can be connected to the supply line by coupler 110B (without regard for the presence or absence of the reel), or the lateral can be connected to the supply line by a coupler disposed at a position along the length of the lateral (without regard for the presence or absence of the reel.

In one example, the method includes physically separating the lateral and the reel. In this example, the lateral remains coupled to the supply line and the reel (either with or without a chassis) can be removed.

### VARIOUS NOTES & EXAMPLES

Example 1 can include or use subject matter such as a system including a lateral having a first end and a second end separated by a length of a lumen, at least one of the first end and second end configured to couple with a fluid supply, the length having a plurality of apertures in a wall of the lumen, each aperture in fluid communication with the lumen and disposed along a line substantially parallel with a length axis, the length configured to allow non-destructive coiling about a reel and non-destructive uncoiling and the length having a cross section sufficiently rigid to resist deformation associated with fluid in the lumen. The system can also include a socket coupled to the length at a site of at least one aperture. The socket is configured to have a bore in fluid communication with the aperture.

Example 2 can include, or can optionally be combined with the subject matter of Example 1, to optionally include wherein the lateral includes a polymer.

Example 3 can include, or can optionally be combined with the subject matter of one or any combination of Examples 1 or 2 to optionally include wherein the socket includes a check valve.

Example 4 can include, or can optionally be combined with the subject matter of one or any combination of Examples 1 through 3 to optionally include wherein the aperture has an aperture wall that includes a cylindrical bore.

Example 5 can include, or can optionally be combined with the subject matter of one or any combination of Examples 1 through 4 to optionally include wherein the aperture has an aperture wall that includes a counter bore.

Example 6 can include, or can optionally be combined with the subject matter of one or any combination of Examples 1 through 5 to optionally include wherein the socket includes threads.

Example 7 can include, or can optionally be combined with the subject matter of one or any combination of Examples 1 through 6 to optionally include wherein the socket is coupled to the length by an engagement feature.

Example 8 can include, or can optionally be combined with the subject matter of one or any combination of Examples 1 through 7 to optionally include wherein the socket is coupled to the length by a leak-resistant joint.

Example 9 can include, or can optionally be combined with the subject matter of one or any combination of Examples 1 through 8 to optionally include wherein the socket is coupled to the length with an interference fit.

Example 10 can include, or can optionally be combined with the subject matter of one or any combination of Examples 1 through 9 to optionally include wherein the socket is coupled to the length with a socket fusion joint.

Example 11 can include, or can optionally be combined with the subject matter of one or any combination of Examples 1 through 10 to optionally include wherein the socket is coupled to the length with a saddle fusion joint.

Example 12 can include, or can optionally be combined with the subject matter of one or any combination of Examples 1 through 11 to optionally include an application device coupled to the socket.

Example 13 can include, or can optionally be combined with the subject matter of one or any combination of Examples 1 through 12 to optionally include wherein the application device includes a riser.

Example 14 can include, or can optionally be combined with the subject matter of one or any combination of Examples 1 through 13 to optionally include wherein the application device includes an outer surface, the outer surface configured to extend based on fluid pressure in the lumen and configured to retract in the absence of fluid pressure.

Example 15 can include, or can optionally be combined with the subject matter of one or any combination of Examples 1 through 14 to optionally include wherein the application device has a profile substantially flush with an external surface of the lateral.

Example 16 can include, or can optionally be combined with the subject matter of one or any combination of Examples 1 through 15 to optionally include wherein the application device is removably coupled to the socket.

Example 17 can include or use subject matter such as a system including a lateral having a first end and a second end separated by a length of a lumen.

At least one of the first end and second end is configured to couple with a fluid supply. The length has a plurality of apertures in a wall of the lumen and each aperture is in fluid communication with the lumen and disposed along a line substantially parallel with a length axis. The length has a lateral wall configured to allow non-destructive coiling about a reel and non-destructive uncoiling and having a substantially rigid cross section. The length is configured to resist deformation associated with fluid in the lumen. At least one aperture has an aperture wall corresponding to the lateral wall, the at least one aperture having an aperture axis substantially normal to the length axis.

Example 18 can include, or can optionally be combined with the subject matter of Example 17, to optionally include wherein the lateral includes a polymer.

Example 19 can include, or can optionally be combined with the subject matter of one or any combination of Examples 17 or 18 to optionally include wherein the aperture wall includes a cylindrical bore.

Example 20 can include, or can optionally be combined with the subject matter of one or any combination of Examples 17 through 19 to optionally include wherein the aperture wall includes a counter bore.

Example 21 can include, or can optionally be combined with the subject matter of one or any combination of Examples 17 through 20 to optionally include an application device coupled to the aperture.

Example 22 can include, or can optionally be combined with the subject matter of one or any combination of Examples 17 through 21 to optionally include wherein the application device includes an outer surface, the outer surface configured to extend based on fluid pressure in the lumen and configured to retract in the absence of fluid pressure.

Example 23 can include, or can optionally be combined with the subject matter of one or any combination of Examples 17 through 22 to optionally include wherein the outer surface is configured to retract to a position substantially flush with an external surface of the lateral.

Example 24 can include, or can optionally be combined with the subject matter of one or any combination of Examples 17 through 23 to optionally include wherein the application device is removably coupled to the aperture.

Example 25 can include, or can optionally be combined with the subject matter of one or any combination of Examples 17 through 24 to optionally include wherein the application device is coupled to the lateral with a socket fusion joint.

Example 26 can include, or can optionally be combined with the subject matter of one or any combination of Examples 17 through 25 to optionally include wherein the application device is coupled to the lateral with a saddle fusion joint.

Example 27 can include, or can optionally be combined with the subject matter of one or any combination of Examples 17 through 26 to optionally include wherein the application device is coupled to the length by an engagement feature.

Example 28 can include, or can optionally be combined with the subject matter of one or any combination of Examples 17 through 27 to optionally include wherein the application device is coupled to the length by a leak-resistant joint.

Example 29 can include, or can optionally be combined with the subject matter of one or any combination of Examples 17 through 28 to optionally include wherein the application device is coupled to the length with an interference fit.

Example 30 can include, or can optionally be combined with the subject matter of one or any combination of Examples 17 through 29 to optionally include wherein the application device includes a riser.

Example 31 can include or use subject matter such as a system including a chassis, a reel, and a lateral. The chassis has a wheeled frame and a bearing. The reel is rotatably coupled to the chassis and configured for transportation on the chassis. The lateral has a first end and a second end separated by a length of a lumen, at least one of the first end and second end configured to couple with a fluid supply, the length having a plurality of apertures in a wall of the lumen, each aperture in fluid communication with the lumen and disposed along a line substantially parallel with a length axis, the length having a lateral wall configured to allow non-destructive coiling about the reel and non-destructive uncoiling and having a substantially rigid cross section, the length configured to resist deformation associated with fluid in the lumen, at least one aperture having an aperture wall corresponding to the lateral wall, the at least one aperture having an aperture axis substantially normal to the length axis.

Example 32 can include, or can optionally be combined with the subject matter of Example 31, to optionally include wherein the lateral is coupled to the reel by a joint.

Example 33 can include, or can optionally be combined with the subject matter of one or any combination of Examples 31 or 32 to optionally include wherein the reel is coupled to the chassis by a joint.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A system comprising:
a lateral having a first end and a second end separated by a length of a lumen, at least one of the first end and second end configured to couple with a fluid supply, the length having a plurality of apertures in a wall of the lumen, each aperture in fluid communication with the lumen and disposed along a line substantially parallel with a length axis, the length configured to allow non-destructive coiling about a reel and non-destructive uncoiling and the length having a cross section sufficiently rigid to resist deformation associated with fluid in the lumen; and
a socket coupled to the length at a site of at least one aperture, the socket having a bore in fluid communication with the aperture.

2. The system of claim 1 wherein the lateral includes a polymer.

3. The system of claim 1 wherein the socket includes a check valve.

4. The system of claim 1 wherein the aperture has an aperture wall that includes a cylindrical bore.

5. The system of claim 1 wherein the aperture has an aperture wall that includes a counter bore.

6. The system of claim 1 wherein the socket includes threads.

7. The system of claim 1 wherein the socket is coupled to the length by an engagement feature.

8. The system of claim 1 wherein the socket is coupled to the length by a leak-resistant joint.

9. The system of claim 1 wherein the socket is coupled to the length with an interference fit.

10. The system of claim 1 wherein the socket is coupled to the length with a fusion joint.

11. The system of claim 1 further including an application device coupled to the socket.

12. The system of claim 11 wherein the application device includes a riser.

13. The system of claim 11 wherein the application device includes an outer surface, the outer surface configured to extend based on fluid pressure in the lumen and configured to retract in the absence of fluid pressure.

14. The system of claim 11 wherein the application device has a profile substantially flush with an external surface of the lateral.

15. The system of claim 11 wherein the application device is removably coupled to the socket.

16. A system comprising:
a lateral having a first end and a second end separated by a length of a lumen, at least one of the first end and second end configured to couple with a fluid supply, the length having a plurality of apertures in a wall of the lumen, each aperture in fluid communication with the lumen and disposed along a line substantially parallel with a length axis, the length having a lateral wall configured to allow non-destructive coiling about a reel and non-destructive uncoiling and having a substantially rigid cross section, the length configured to resist deformation associated with fluid in the lumen, and at least one aperture having an aperture wall corresponding to the lateral wall, the at least one aperture having an aperture axis substantially normal to the length axis.

17. The system of claim 17 wherein the lateral includes a polymer.

18. The system of claim 16 wherein the aperture wall includes a cylindrical bore.

19. The system of claim 16 wherein the aperture wall includes a counter bore.

20. The system of claim 16 further including an application device coupled to the aperture.

21. The system of claim 20 wherein the application device includes an outer surface, the outer surface configured to extend based on fluid pressure in the lumen and configured to retract in the absence of fluid pressure.

22. The system of claim 21 wherein the outer surface is configured to retract to a position substantially flush with an external surface of the lateral.

23. The system of claim 20 wherein the application device is removably coupled to the aperture.

24. The system of claim 20 wherein the application device is coupled to the lateral with a fusion joint.

25. The system of claim 20 wherein the application device is coupled to the length by an engagement feature.

26. The system of claim 20 wherein the application device is coupled to the length by a leak-resistant joint.

27. The system of claim 20 wherein the application device is coupled to the length with an interference fit.

28. A system comprising:
a chassis having a wheeled frame and a bearing;
a reel rotatably coupled to the chassis and configured for transportation on the chassis; and
a lateral having a first end and a second end separated by a length of a lumen, at least one of the first end and second end configured to couple with a fluid supply, the length having a plurality of apertures in a wall of the lumen, each aperture in fluid communication with the lumen and disposed along a line substantially parallel with a length axis, the length having a lateral wall configured to allow non-destructive coiling about the reel and non-destructive uncoiling and having a substantially rigid cross section, the length configured to resist deformation associated with fluid in the lumen, at least one aperture having an aperture wall corresponding to the lateral wall, the at least one aperture having an aperture axis substantially normal to the length axis.

29. The system of claim 28 wherein the lateral is coupled to the reel by a joint.

30. The system of claim 28 wherein the reel is coupled to the chassis by a joint.
